(19) United States
(12) Patent Application Publication
(10) Pub. No.: US 2006/0004618 A1
(43) Pub. Date: Jan. 5, 2006

(54) Explaining task scheduling for a project

(75) Inventor: Nathan Brixius, Seattle, WA (US)

Correspondence Address: PERKINS COLE LLP/MSFT, P. O. BOX 1247, SEATTLE, WA, 98111-1247, US

(73) Assignee: Microsoft Corporation, Redmond, WA (US)

(21) Appl. No.: 10/881,900

(22) Filed: Jun. 30, 2004

(51) Int. Cl. G06Q 10/00

(52) U.S. Cl. 705/8; 705/7

(57) ABSTRACT

Techniques for causing project management software to explain task scheduling for a project are provided. A technique for explaining task scheduling for a project analyzes every task of the project, stores an indication of an explanation relating to a primary consideration for determining a schedule for the task, and then determines a schedule for the task. A primary consideration for determining a schedule for a task is a consideration that is actually used to determine the schedule for the task from a set of considerations that could be used. The stored indication of an explanation may be used to generate an explanation that is provided to a user using one or more of a variety of user interfaces. By storing the indications during analysis and providing the indications using a user interface, the project management software may enable its user to better understand portions of a project's schedule.

### TECHNICAL FIELD

The technology disclosed herein relates generally to scheduling projects and, more particularly, to explaining task scheduling for a project.

### BACKGROUND

Projects are endeavors involving multiple tasks that are together completed for a purpose, such as creating products or services. Projects include, e.g., erecting bridges or buildings, creating software, and shooting movies. Tasks involved in a project for erecting a building may include, e.g., acquiring materials, hiring a general contractor, and laying a foundation. Each project or some of its tasks may have various constraints such as time, cost, and scope. Time constraints include, e.g., a specified start or finish date. Cost constraints include availability of resources such as people and equipment that may perform the tasks. As an example, an electrician may only be available during a period of time. Scope constraints include, e.g., quality, features, and functions. As an example, an architect may specify a number of windows. A subset of the project's tasks may also have dependencies on other tasks. As an example, materials may need to be acquired before the foundation can be laid. These considerations, comprising at least constraints and dependencies, may be analyzed when determining a project schedule.

A project manager determines and manages a project's schedule by analyzing and balancing the considerations. Analyzing considerations may involve, e.g., determining in what order tasks are to be performed, which resources will perform the tasks, and the duration of the tasks. Balancing considerations may involve, e.g., adjusting or reducing one or more of the considerations to affect a third considerations. As an example, the project manager may add resources or remove features to reduce the total time for a task or project that is behind schedule. Alternatively, if project scope must be increased because of new requirements, resources may need to be increased so that a task or the project does not become delayed.

Project managers may use project management software such as MICROSOFT PROJECT to assist in managing their projects. A project manager may use project management software to track all information relating to a project such as tasks, duration of tasks, resources, and other considerations. When this project information is specified, the project management software may automatically provide project feedback, such as by adjusting completion time of a task based on adjustments to considerations, graphically displaying relationships between the project's tasks, and estimating completion dates and costs based on indicated progress. As an example, if a project comprises three tasks and the project ends at the completion of a task, the project may end sooner if the project manager assigns an additional resource to the task. Thus, the project manager is able to use the project management software to create, predict, analyze, and manage project schedules.

A project manager may provide as input to project management software a variety of information relevant to a project. This information may include work periods, tasks, resources, and progress. Work period information may include, e.g., work days and work hours. Task information may include, e.g., names, durations, relationships to other tasks, and resources assigned to the tasks. Resource information may include, e.g., types, names, costs, and work hours. Progress information may include an initial project plan (sometimes referred to as a “baseline”), task completion, and actual values. Actual values describe previously completed portions of the project plan. Examples of actual values include, e.g., start date, finish date, duration, and cost. The project management software may use this information to determine an initial project schedule.

When the project manager provides additional input or adjusts one of the previously provided inputs, a scheduler component of the project management software may reschedule one or more tasks automatically. As an example, when a project has many tasks with multiple dependencies or constraints, a change to the expected duration of a task may cause the scheduler component to reschedule, e.g., the start or finish dates of other tasks, and potentially the overall project schedule. In a complicated project, the project manager may not understand why the adjustment caused the scheduler component to reschedule other tasks, how the rescheduling was determined, or how to resolve issues resulting from the adjustment. When a project manager does not understand why the project management software reschedules tasks, the project manager may be less comfortable with schedules determined by the project management software, and may be less likely to continue to use the project management software. It would thus be highly desirable for a project scheduler component to be able to explain task scheduling for a project.

### SUMMARY

Techniques for causing project management software to explain task scheduling for a project are provided. A technique for explaining task scheduling for a project analyzes a subset of tasks of the project, stores an indication of an explanation relating to a primary consideration for determining a schedule for tasks, and then determines a schedule for the tasks. A primary consideration for determining a schedule for a task is a consideration that is actually used to determine the schedule for the task from a subset of considerations that could be used. The stored indication of an explanation may be used to generate an explanation that is provided to a user using one or more of a variety of user interfaces. By storing the indications during analysis and providing the indications using a user interface, the project management software may enable its user to better understand various aspects of a project's schedule.

### BRIEF DESCRIPTION OF THE DRAWINGS

FIG. 1 illustrates a user interface of project management software in an embodiment.

FIG. 2 illustrates a user interface of project management software in an embodiment.

FIG. 3 illustrates a user interface of project management software in an embodiment in which explanation of schedule information is provided in a tool tip.

FIG. 4 illustrates a user interface of project management software in an embodiment in which explanation of schedule information is provided in a smart tag.

FIG. 5 illustrates a user interface of project management software in an embodiment in which explanation of schedule information is provided in a text box of a dialog relating to task information.

FIG. 6 illustrates a user interface of project management software in an embodiment in which explanation of schedule information is provided in a tool tip.

FIG. 7 illustrates a user interface of project management software in an embodiment in which explanation of schedule information is provided in a textual area of the user interface.

FIG. 8 is a block diagram illustrating an embodiment of components of project management software.

FIG. 9 is a flow diagram illustrating an embodiment of a schedule_tasks routine performed by the scheduler component.

FIG. 10 is a block diagram illustrating an embodiment of a data structure relating to a project and its tasks.

FIG. 11 is a block diagram illustrating an embodiment of a data structure relating to a task.

FIG. 12 illustrates an example of a suitable computing system environment in which the facility may be implemented.

### DETAILED DESCRIPTION

Overview

Techniques for causing project management software to explain task scheduling for a project are provided. In an embodiment, a system for explaining task scheduling for a project analyzes a subset of tasks of the project, stores an indication of an explanation relating to a primary consideration for determining a schedule for tasks, and then determines a schedule for the tasks. A primary consideration for determining a schedule for a task is a consideration that is actually used to determine the schedule for the task from a subset of considerations that could be used. As an example, when a successor task can begin only after three other predecessor tasks end, the primary consideration may be a predecessor task with the last completion date because the successor task can only begin after the last predecessor task ends. The stored indication of an explanation may be used to generate an explanation that is provided to a user using one or more of a variety of user interfaces. As examples, the indication may be displayed using a tool tip, a smart tag, a change in color, text in a dialog box, or a variety of other means of providing feedback to users. By storing the indications during analysis and providing the indications using a user interface, the project management software may enable its user to better understand portions of a project's schedule.

Figures

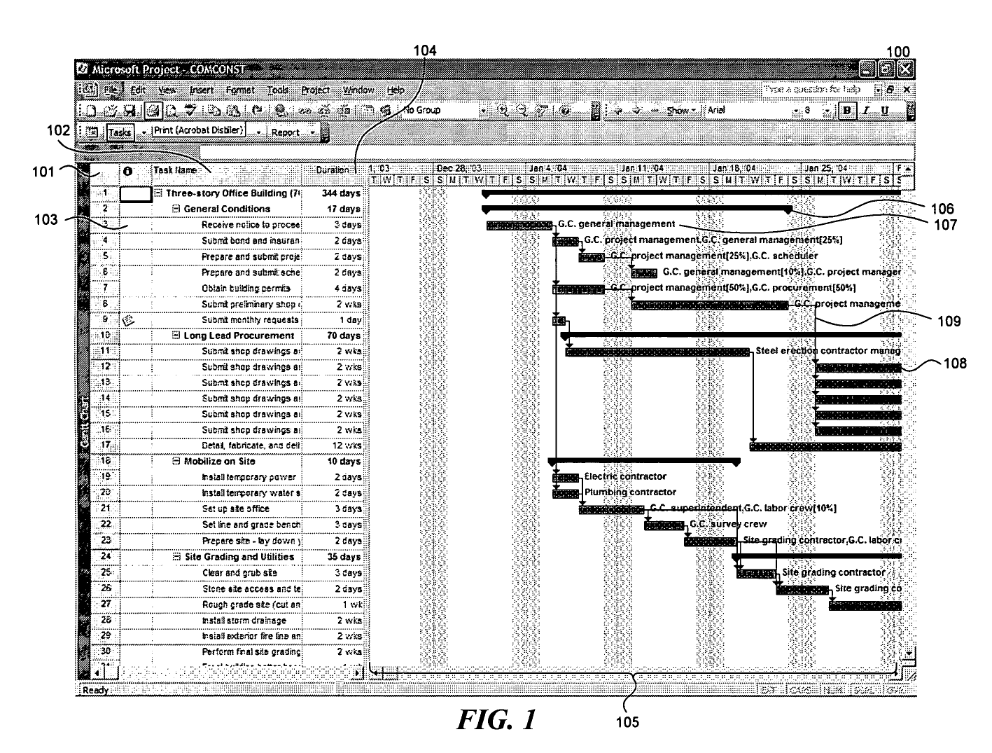

Turning now to the figures, FIGS. 1-7 illustrate various aspects of a user interface of project management software incorporating the techniques described herein.

FIG. 1 illustrates a user interface of project management software in an embodiment. The project management software may use a windowing environment such as MICROSOFT WINDOWS. The main window of the project management software 100 comprises a textual area for textually displaying and receiving information, and a graphical area for graphically displaying and receiving information. As an example, the textual area may display information relating to tasks such as a number 101, a name 102, and a duration 104. As a further example, the graphical area may display information relating to tasks and their schedule as a Gantt chart 105. The textual area and the graphical area may together be referred to as a project plan window.

A user may be able to input information directly into the textual area by selecting a row, e.g., row 103 corresponding to task number 3, and typing information or performing other user interface operations in a manner generally similar to that which would be performed when using spreadsheet software. As examples, the user may be able to type a name or description for a task, a duration for the task, and indicate that the task is a subtask of a summary task 106.

Each task may have one or more resources assigned to the task. These resources may be displayed in the Gantt chart adjacent to the bar for the task, such as resource 107. In the illustrated example, a “G.C. general management” resource is assigned to task number 3.

Tasks may be linked with one another to indicate time-related dependencies. As an example, a successor task may only be capable of beginning after a predecessor task is completed. This relationship between predecessor and successor tasks may be referred to as a dependency. A dependency that causes a successor task to begin after a predecessor task ends may be referred to as a finish-to-start dependency. When tasks have a time-related dependency (e.g., a finish-to-start or other dependency), the project management software may indicate the dependency on the Gantt chart using an arrow, such as arrow 109. Other time-related dependencies include, e.g., start-to-start, finish-to-finish, and start-to-finish (not shown). A start-to-start dependency may be used when two tasks should start at the same time; a finish-to-finish dependency may be used when two tasks should finish at the same time; and a start-to-finish dependency may be used when the start date of a predecessor task determines the finish date of a successor task.

The user may be able to set or modify schedule information relating to a task (e.g., a constraint or dependency) using bars of the Gantt chart. As an example, the user may drag a left or right boundary of the bar 108 to change the associated task's start date or end date. As a further example, the user may be able to drag and drop the bar to indicate that the task is a sub-task of a summary task (e.g., by moving the bar's position vertically) or change the task's schedule (e.g., by moving the bar's position horizontally).

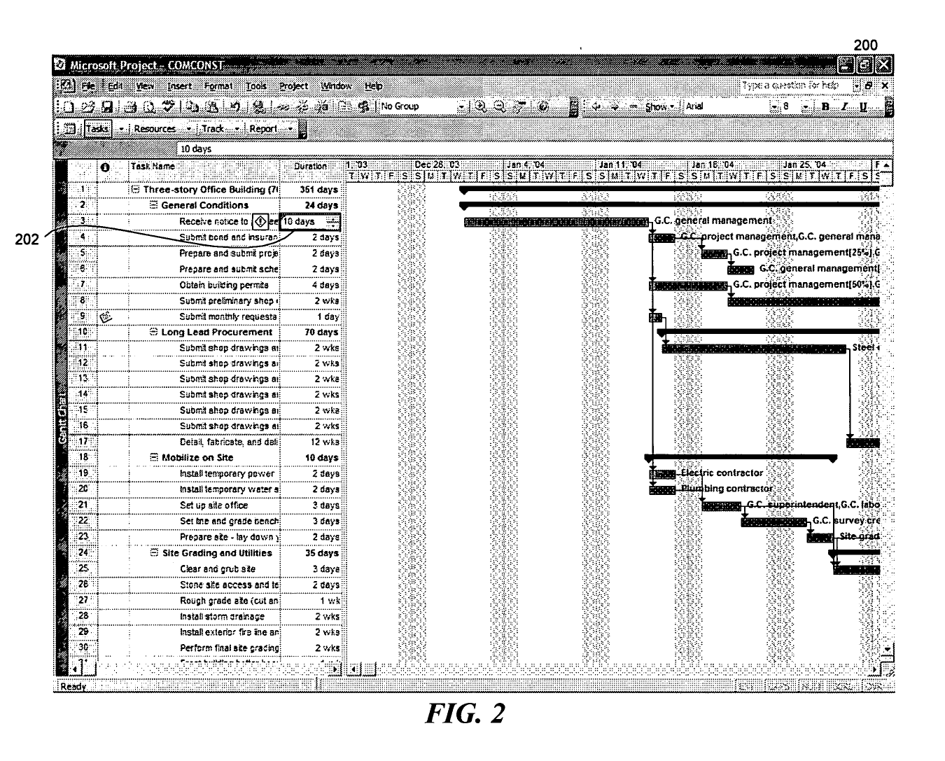

FIG. 2 illustrates a user interface of project management software in an embodiment. Once schedule-related information is entered into the project management software (or retrieved from storage), various aspects of the user interface of the project management software 200 may be used to modify the previously entered information. As an example, the duration of a task may be modified by either typing in a new duration, or by selecting the duration and manipulating user interface controls that appear in relation to the selected task. In the illustrated example, a duration 202 of task 3 is modified to indicate that the task's duration is 10 days, and not 3 days as previously entered and shown in FIG. 1.

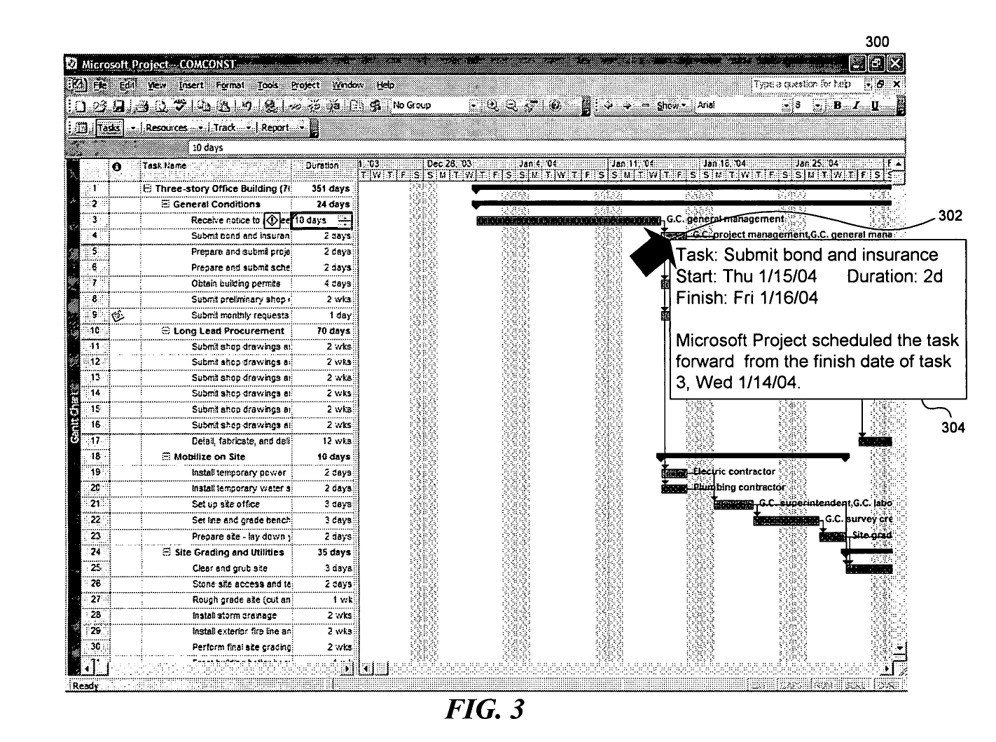

FIG. 3 illustrates a user interface of project management software in an embodiment in which explanation of schedule information is provided in a tool tip. When a user momentarily positions a mouse pointer over a bar, the project management software may display a “tool tip.” A tool tip is typically an informational message that appears near a user interface element or object over which a user momentarily positions a mouse pointer. The tool tip of a Gantt chart bar may indicate a name or description of the task, the task's start and finish dates, the task's duration, and a message indicating why the task was scheduled (or rescheduled).

In the illustrated user interface 300, a user has momentarily positioned a mouse pointer 302 over a bar of a Gantt chart relating to task number four of the illustrated project. As a result, a tool tip 304 appears describing task number 4. The tool tip indicates that the task's name is “Submit bond and insurance”; the task begins on Thursday, Jan. 15, 2004, lasts two days and ends on Friday, January 16; and the task was scheduled forward from the finish date of task number 3, which finishes on Wednesday, January 14. Task number 4 may have been scheduled forward from the finish date of task number 3 because task number 4 is a successor task of task number 3 and has a finish-to-start constraint on task number 3.

The project management software may provide a variety of informational messages. As examples, informational messages may indicate schedule adjustments based on time or resource constraints, or indeed any schedule consideration. Thus, the project management software may provide information to the user indicating an explanation of the schedule adjustment in a tool tip.

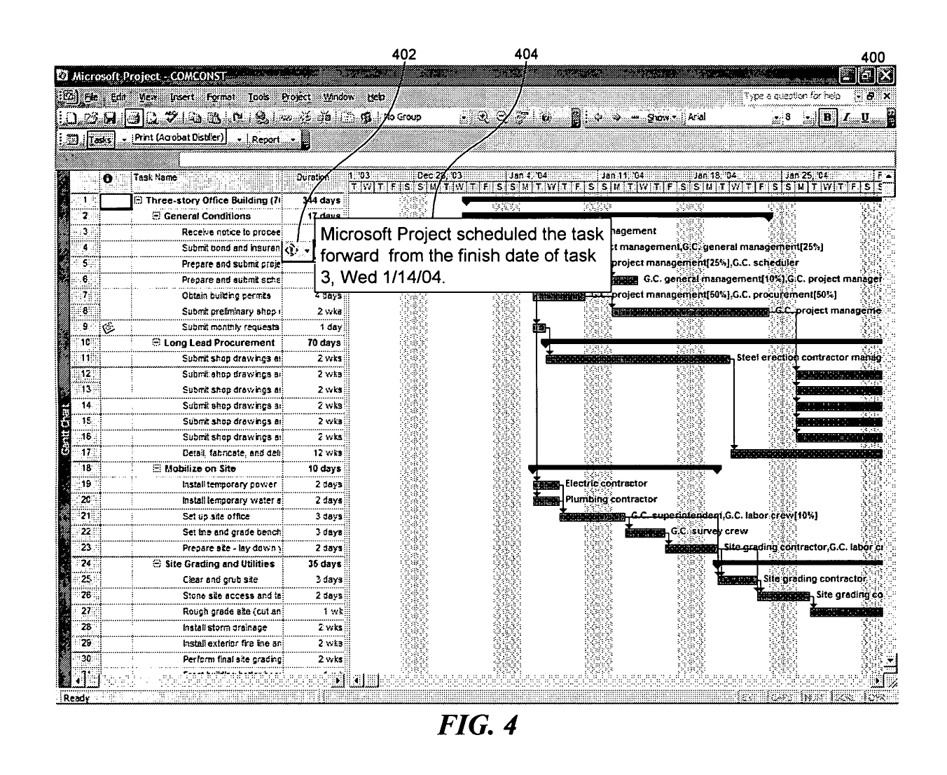

FIG. 4 illustrates a user interface of project management software in an embodiment in which explanation of schedule information is provided in a smart tag. In the illustrated user interface 400, a user has selected a smart tag indicator 402 relating to task number 4 of the illustrated project. When a user selects a smart tag indicator, the project management software may display a smart tag as an informational window associated with the indicator. A smart tag may include text and associated intelligence or logic. As an example, text included with smart tag 404 indicates that the task was scheduled forward from the finish date of task number 3. Associated logic (not shown) may include, e.g., fixing the start date of task number 4 and rescheduling its predecessor tasks (e.g., task number 3) such that they end at the fixed start date of task number 4. Other actions may also be possible. As an example, the smart tag may indicate that another resource is available to help complete task number 3 (or number 4) such that the finish dates of task numbers 3 or 4 can be readjusted. Thus, the project management software may provide information to the user indicating an explanation of the schedule adjustment for the task in a smart tag, and enable the user to perform other actions associated with the schedule adjustment.

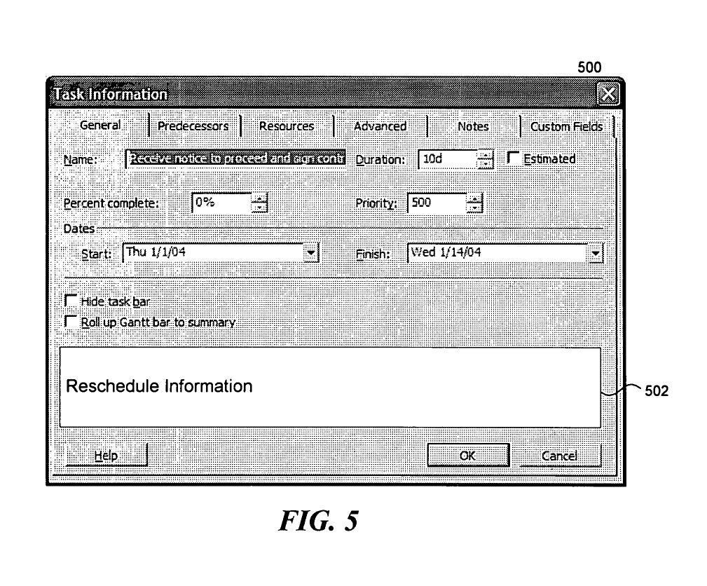

FIG. 5 illustrates a user interface of project management software in an embodiment in which explanation of schedule information is provided in a text box of a dialog relating to task information. In the illustrated user interface, a dialog box 500 provides information relating to a task to a user and receives information relating to the task from the user. A user may request the dialog box by using any of a variety of gestures using the user interfaces of FIGS. 1-4. As examples, the user may “double-click” on a task using a mouse or select a menu option after selecting a task. In the dialog box that appears, a text box 502 may provide an explanation of schedule information that the project management software has determined for an indicated task (i.e., a task for which the dialog box was requested). As an example, the text box may provide an explanation that the indicated task was rescheduled because of an adjustment of a task on which the indicated task has a dependency. The information provided in the text box may be similar or equivalent to information provided in tool tip 304 or smart tag 404. Alternatively, the information provided in the text box may be more or less detailed than the information provided in the tool tip or the smart tag. Thus, the project management software may provide information to the user indicating an explanation of the schedule adjustment for the task in a text box of a dialog box.

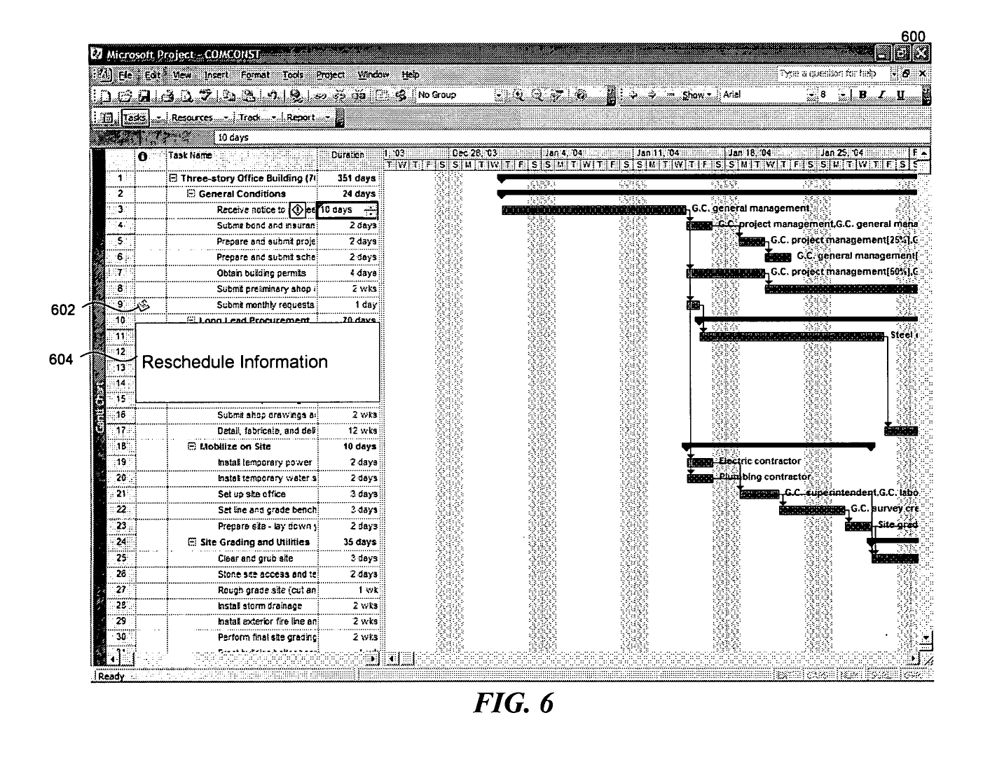

FIG. 6 illustrates a user interface for project management software in an embodiment in which explanation of schedule information is provided in a tool tip. In a manner similar to that described in relation to FIG. 3, a user may momentarily position a mouse pointer over, e.g., an icon relating to a task. As an example, in the illustrated user interface 600, a user has momentarily positioned a mouse pointer (not shown) over a notes icon 602 relating to task number 9 of the illustrated project. When the user does so, a tool tip 604 may appear containing an explanation of schedule information for the task. Other informational icons may also be used instead of or in addition to the notes icon. As an example, an informational icon may appear indicating that an explanation is available.

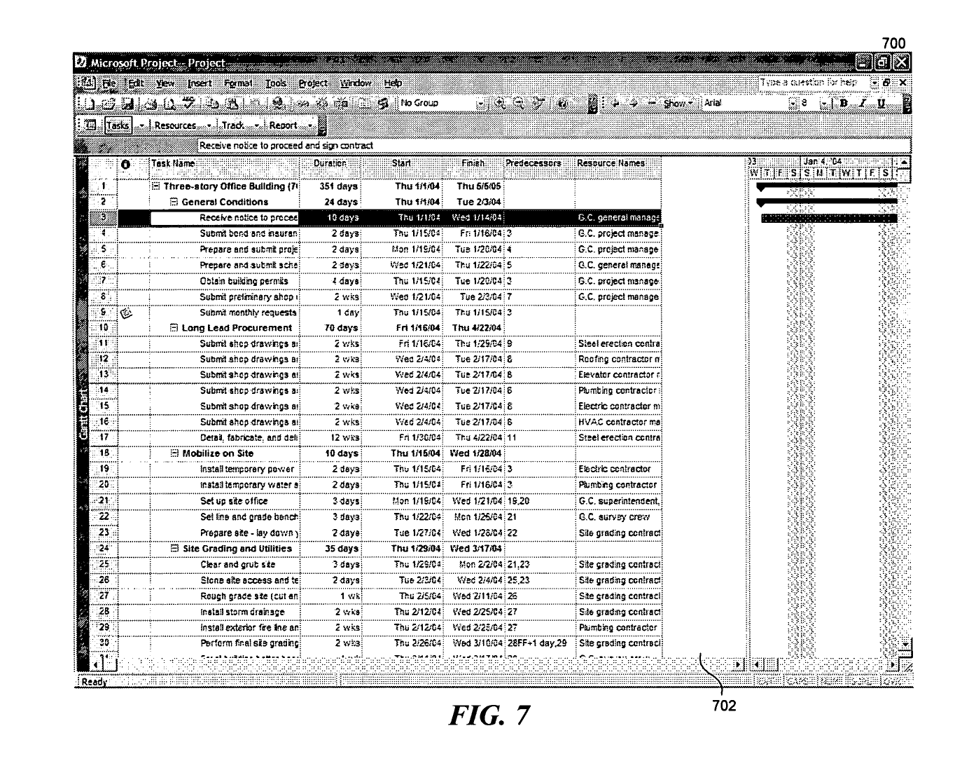

FIG. 7 illustrates a user interface of project management software in an embodiment in which explanation of schedule information is provided in a textual area of the user interface. The illustrated user interface 700 may comprise a column 702 that may contain an indication of an explanation of schedule information for each task.

In an embodiment, a change in color, shape, or other format may indicate a primary consideration relating to a task's schedule. As examples, an arrow indicating a dependency between two tasks may appear in a different color or in a different format (e.g., bold) to indicate a primary consideration. Similarly, a bar of a Gantt chart may appear in a different color or shape to indicate that it is a primary consideration.

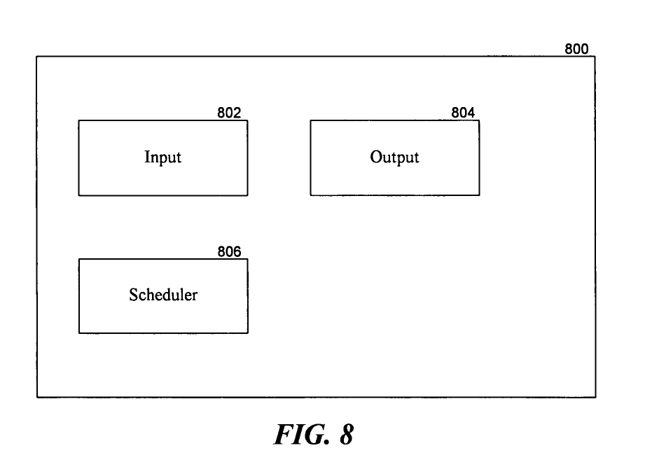

FIG. 8 is a block diagram illustrating an embodiment of components of project management software. The illustrated project management software 800 comprises an input component 802, an output component 804, and a scheduler component 806.

The input component may receive data from a user or other software. The user may provide data using any of a number of user interface elements of the project management software. As an example, the user may type information using a keyboard. Alternatively, the user may retrieve information from storage, such as by retrieving a previously stored schedule. Other software may provide data using an application program interface (“API”) of the project management software. The input component may store the received data in a schedule file, such as in primary storage (e.g., random access memory) or in secondary storage (e.g., hard disk).

The output component may provide output of schedule information in a variety of means. As examples, the output component may provide schedule information in a Gantt chart, report, or table, or by using an API of other software to communicate the schedule information to the other software.

The scheduler component may determine a schedule for each task based on data received by the input component. The scheduler component may also determine a schedule for tasks based on schedule considerations, such as constraints or dependencies relating to other tasks. Other scheduling considerations may include, e.g., task constraints, actual values that have been reported on a task, start or finish dates of the project or its tasks, status dates for the project or its tasks, dependencies on other projects, or dependencies on milestones or phases within the project or other projects.

The scheduler component may also determine a schedule for tasks based on operations performed by a user, such as when leveling resources. The user may level resources to, e.g., ensure that a resource is not assigned to more tasks than the resource is capable of completing.

While the scheduler component determines a schedule for each task, it may store an indication of an explanation for the task's schedule. As an example, the scheduler component may store an indication of an explanation relating to a primary consideration for determining a schedule for the task. A primary consideration for determining a schedule for a task is a consideration that is actually used to determine the schedule for the task from a subset of considerations that could be used. As an example, when a successor task can begin only after three other predecessor tasks end, the primary consideration may be the predecessor task with the last completion date.

Primary considerations may include tasks that are on a critical path. A critical path is a subset of tasks that, if delayed, could delay the project with which the tasks are associated.

The stored indication of an explanation may be used by the output component to generate an explanation that is later provided to a user. As an example, the indications may be stored in a form that a human may not easily comprehend, and the output component may convert the indications into human-readable text for display to the user.

Thus, the project management software may store annotations or other indications explaining task scheduling as each task is scheduled.

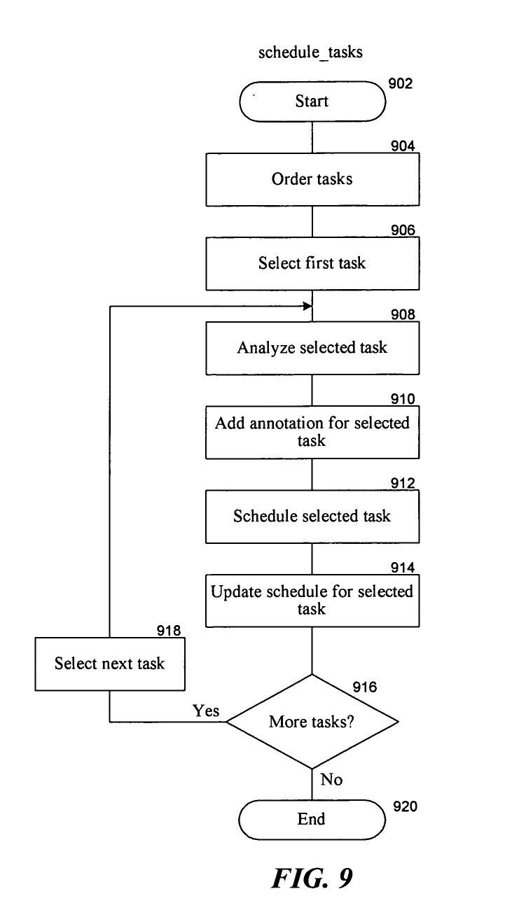

FIG. 9 is a flow diagram illustrating an embodiment of a schedule_tasks routine performed by the scheduler component. The routine begins at block 902. At block 904, the routine may order tasks for scheduling. Ordering the tasks for scheduling may involve placing predecessor tasks earlier in the orderthan successor tasks, which may cause scheduling to be performed for predecessor tasks before successor tasks.

At block 906, the routine selects the first of the ordered tasks.

In blocks 908-914, the routine may determine a primary consideration for a subset of tasks, provide an explanation relating to the scheduling for the tasks, and determine a schedule for the tasks. The scheduling for the tasks may include an indication of a primary consideration.

At block 908, the routine may analyze the selected task. Analyzing the selected task may include, e.g., determining which of a set (or subset) of considerations for the selected task is a primary consideration. As an example, a predecessor task that ends last may be a primary consideration for a successor task that has a finish-to-start dependency on the primary consideration.

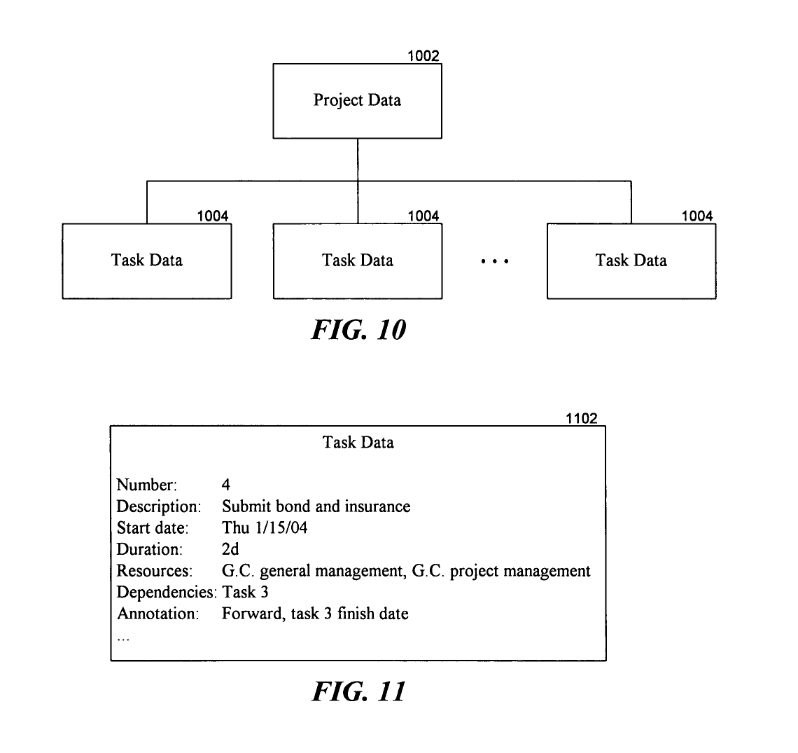

At block 910, the routine may store an indication of an explanation for the task's schedule. The routine may store this indication as an annotation relating to the selected task. As an example, the routine may store the indication in a data structure comprising data relating to the task (described in further detail below in relation to FIG. 10). By storing the indication at the time of determining a schedule for the task, an accurate explanation for the task's schedule can be preserved.

At block 912, the routine may determine a schedule for the selected task. The routine may call a subroutine of the scheduler component or an altogether different component to determine the schedule for the task (not shown). Thus, the applicants'technique is compatible with a variety of project management software, including MICROSOFT PROJECT.

At block 914, the routine may update schedule information for the selected task. At block 912, the routine may store the schedule determined in a data structure associated with the task.

At block 916, the routine may determine whether there are additional tasks to analyze. If there are additional tasks, the routine continues at block 918. Otherwise, the routine continues at block 920. At block 918, the routine selects the next task and then continues at block 908.

At block 920, the routine returns to its caller.

By performing these steps, the scheduler component may have determined a schedule for each task of a project and may also have indicated an explanation for determining the schedule.

FIGS. 10-11 illustrate data structures associated with projects and tasks. The data structures may store data provided by a user using a user interface of the project management software, or other software using an API exposed by the project management software, and may also store data or other information produced or determined by the project management software. The data structures may be stored in primary or secondary storage.

FIG. 10 is a block diagram illustrating an embodiment of a data structure relating to a project and its tasks. Each project may have project-related data stored in a data structure associated with the project 1002. As examples, project-related data may include a project name, a project start date, and project holidays. Project-related data may also include an indication of a number of tasks and their associated task-related data structures 1004. Each task-related data structure comprises input data or other information relating to a task (further described below in relation to FIG. 11).

FIG. 11 is a block diagram illustrating an embodiment of a data structure relating to a task. The task data structure 1102 may comprise input data and other information associated with a task. As examples, task-related data may include, e.g., a task number, description, start date, duration, resources assigned to the task, dependencies or constraints, and an annotation or explanation relating to the task's schedule. The task-related data may also comprise additional information (not shown). There may be a one-to-one correspondence between the number of task data structures to and the number of tasks associated with the project. In the illustrated embodiment, the task data structure 1102 is shown containing data corresponding to task number 4 as indicated in FIG. 4. There may be additional task data structures for each of the other tasks in the project indicated in FIG. 4 (not shown).

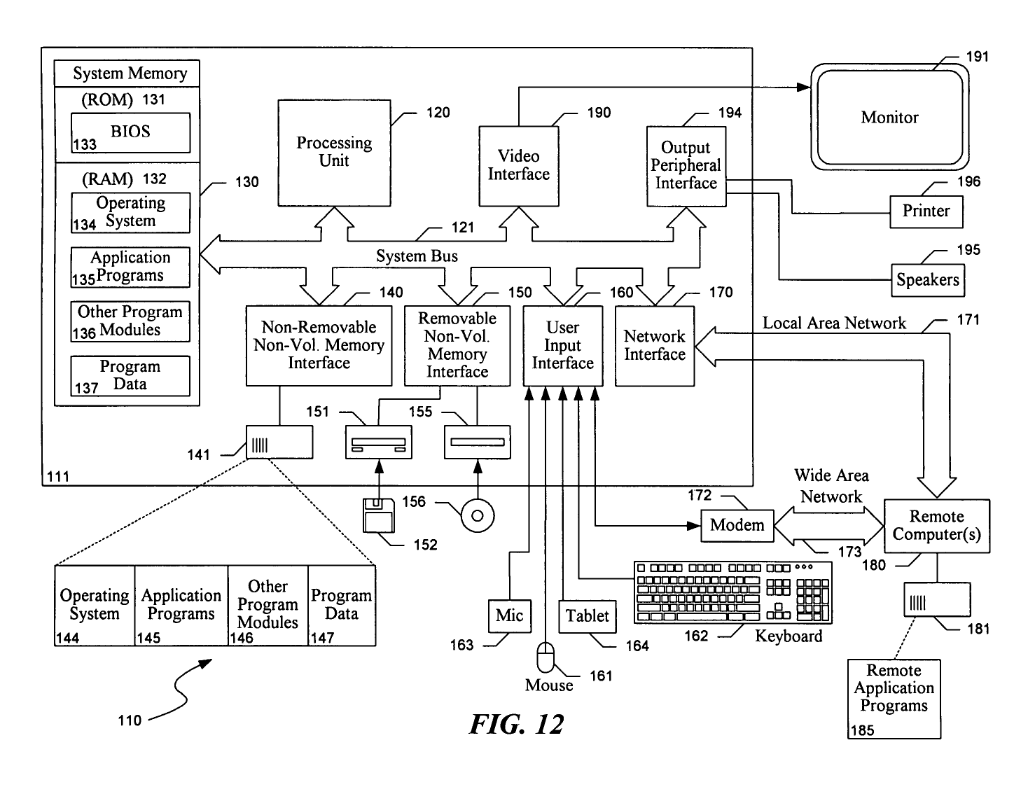

FIG. 12 illustrates an example of a suitable computing system environment 110 or operating environment in which the facility may be implemented. The computing system environment 110 is only one example of a suitable computing environment and is not intended to suggest any limitation as to the scope of use or functionality of the facility. Neither should the computing system environment 110 be interpreted as having any dependency or requirement relating to any one or a combination of components illustrated in the exemplary operating environment 110.

The facility is operational with numerous other general purpose or special purpose computing system environments or configurations. Examples of well-known computing systems, environments, and/or configurations that may be suitable for use with the facility include, but are not limited to, personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The facility may be described in the general context of computer-executable instructions, such as program modules, being executed by a computer. Generally, program modules include routines, programs, objects, components, data structures, and so forth that perform particular tasks or implement particular abstract data types. The facility may also be practiced in distributed computing environments where tasks are performed by remote processing devices that are linked through a communications network. In a distributed computing environment, program modules may be located in local and/or remote computer storage media including memory storage devices.

With reference to FIG. 12, an exemplary system for implementing the facility includes a general purpose computing device in the form of a computer 111. Components of the computer 111 may include, but are not limited to, a processing unit 120, a system memory 130, and a system bus 121 that couples various system components including the system memory 130 to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 111 typically includes a variety of computer-readable media. Computer-readable media can be any available media that can be accessed by the computer 111 and includes both volatile and nonvolatile media and removable and nonremovable media. By way of example, and not limitation, computer-readable media may comprise computer storage media and communication media. Computer storage media include volatile and nonvolatile, removable and nonremovable media implemented in any method or technology for storage of information such as computer-readable instructions, data structures, program modules, or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 111. Communication media typically embody computer-readable instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system (BIOS) 133, containing the basic routines that help to transfer information between elements within the computer 111, such as during start-up, is typically stored in ROM 131. RAM 132 typically contains data and/or program modules that are immediately accessible to and/or presently being operated on by the processing unit 120. By way of example, and not limitation, FIG. 12 illustrates operating system 134, application programs 135, other program modules 136 and program data 137.

The computer 111 may also include other removable/nonremovable, volatile/nonvolatile computer storage media. By way of example only, FIG. 12 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a nonremovable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 12, provide storage of computer-readable instructions, data structures, program modules, and other data for the computer 111. In FIG. 12, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 111 through input devices such as a tablet or electronic digitizer 164, a microphone 163, a keyboard 162 and pointing device 161, commonly referred to as a mouse, trackball or touch pad. Other input devices not shown in FIG. 12 may include a joystick, game pad, satellite dish, scanner, or the like. These and other input devices are often connected to the processing unit 120 through a user input interface 160 that is coupled to the system bus 121, but may be connected by other interface and bus structures, such as a parallel port, game port, or a universal serial bus (USB). A monitor 191 or other type of display device is also connected to the system bus 121 via an interface, such as a video interface 190. The monitor 191 may also be integrated with a touch-screen panel or the like. Note that the monitor 191 and/or touch screen panel can be physically coupled to a housing in which the computer 111 is incorporated, such as in a tablet-type personal computer. In addition, computing devices such as the computer 111 may also include other peripheral output devices such as speakers 195 and printer 196, which may be connected through an output peripheral interface 194 or the like.

The computer 111 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computer 111, although only a memory storage device 181 has been illustrated in FIG. 12. The logical connections depicted in FIG. 12 include a local area network (LAN) 171 and a wide area network (WAN) 173, but may also include other networks. Such networking environments are commonplace in offices, enterprisewide computer networks, intranets and the Internet. For example, in the present facility, the computer 111 may comprise the source machine from which data is being migrated, and the remote computer 180 may comprise the destination machine. Note, however, that source and destination machines need not be connected by a network or any other means, but instead, data may be migrated via any media capable of being written by the source platform and read by the destination platform or platforms.

When used in a LAN networking environment, the computer 111 is connected to the LAN 171 through a network interface or adapter 170. When used in a WAN networking environment, the computer 111 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 111, or portions thereof, may be stored in the remote memory storage device 181. By way of example, and not limitation, FIG. 12 illustrates remote application programs 185 as residing on memory storage device 181. It will be appreciated that the network connections shown are exemplary and other means of establishing a communications link between the computers may be used.

While various functionalities and data are shown in FIG. 12 as residing on particular computer systems that are arranged in a particular way, those skilled in the art will appreciate that such functionalities and data may be distributed in various other ways across computer systems in different arrangements. While computer systems configured as described above are typically used to support the operation of the facility, one of ordinary skill in the art will appreciate that the facility may be implemented using devices of various types and configurations, and having various components.

The techniques for causing project management software to explain task scheduling for a project may be described in the general context of computer-executable instructions, such as program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I claim:

1. A method performed by a computing system for explaining scheduling considerations for a project, comprising:
receiving information defining each of a set of schedule tasks for the project; and
for each schedule task,
analyzing scheduling considerations for the schedule task; and
based on the analysis,
determining a schedule for the schedule task; and
storing information identifying a reason for determining the schedule for the schedule task.

2. The method of claim 1 wherein at least one of the analyzed scheduling considerations is a constraint and the determining includes satisfying the constraint.

3. The method of claim 2 wherein the reason includes an indication of the constraint.

4. The method of claim 1 wherein at least one of the analyzed scheduling considerations is a dependency on another schedule task and the analyzing includes analyzing the dependency and scheduling considerations for the other schedule task.

5. The method of claim 4 wherein the reason includes an indication of the other schedule task.

6. The method of claim 1 wherein the analyzing includes selecting a scheduling consideration that primarily affects the schedule for the schedule task.

7. The method of claim 6 wherein the storing includes storing information identifying the selected scheduling consideration.

8. The method of claim 6 wherein the scheduling consideration is a schedule task.

9. The method of claim 6 wherein the scheduling consideration is a resource.

10. The method of claim 1 wherein the analyzing includes storing one of a plurality of scheduling considerations selected as primarily affecting the schedule for the schedule task.

11. The method of claim 1 including displaying an indication of the reason.

12. The method of claim 11 wherein the indication is a tool tip.

13. The method of claim 11 wherein the indication is a change of a color of an item in a user interface.

14. The method of claim 13 wherein the item is an arrow indicating a relationship between schedule tasks.

15. The method of claim 11 wherein the indication is a smart tag.

16. The method of claim 11 wherein the indication appears in a dialog box.

17. The method of claim 1 wherein the storing is performed before a subsequent schedule task is analyzed.

18. The method of claim 1 wherein at least one of the analyzed scheduling considerations relates to another project.

19. A method performed by a computing system for explaining scheduling considerations for a project, comprising:
receiving information defining each of a subset of schedule tasks for the project; and
for every schedule task of the subset of schedule tasks, performing an
analysis process, wherein the analysis process comprises:
analyzing scheduling considerations for the selected schedule task; and
based on the analysis, determining a schedule for the schedule task and storing information identifying a reason for determining the schedule for the schedule task.

20. The method of claim 19 wherein the analyzed scheduling considerations comprise a constraint and determining the schedule includes satisfying the constraint.

21. The method of claim 20 wherein the identified reason includes an indication of the constraint.

22. The method of claim 19 wherein at least one of the analyzed scheduling considerations is a dependency on another schedule task and the analyzing includes analyzing the dependency and scheduling considerations for the other schedule task.

23. The method of claim 22 wherein the identified reason includes an indication of the other schedule task.

24. The method of claim 19 wherein the analyzing includes selecting a scheduling consideration that primarily affects the schedule for the schedule task.

25. The method of claim 24 wherein the storing includes storing information identifying the selected scheduling consideration.

26. A computer-readable medium containing a data structure employed for explaining scheduling considerations for a project, the project having multiple schedule tasks, the computer-readable medium comprising:
for each schedule task of at least a subset of schedule tasks,
a description for the schedule task;
a list of constraints for the schedule task;
a schedule for the schedule task; and
an indication of a reason for the schedule of the schedule task.

27. The computer-readable medium of claim 26 wherein the indication includes an indication of another schedule task that is a primary consideration for the schedule.

28. The computer-readable medium of claim 26 wherein the indication includes an indication of a resource that is a primary consideration for the schedule.

29. A system for explaining scheduling considerations for a project, comprising:
a component that (1) analyzes input to determine a schedule for a schedule task, wherein the analysis includes determining a primary scheduling consideration, and (2) stores an indication of an explanation for the schedule for the schedule task.

30. The system of claim 29 wherein the primary consideration is a constraint.

31. The system of claim 29 wherein the primary consideration is an actual value reported for a task.

32. The system of claim 29 wherein the primary consideration is a start date of the project.

33. The system of claim 29 wherein the primary consideration is an end date of the project.

34. The system of claim 29 wherein the primary consideration is a dependency.

35. The system of claim 34 wherein the dependency relates to a task of the project.

36. The system of claim 34 wherein the dependency relates to a task of another project.
